(19) United States
(12) Patent Application Publication
(10) Pub. No.: US 2003/0058295 A1
(43) Pub. Date: Mar. 27, 2003

(54) Printing mechanism swath height and line-feed error compensation

(76) Inventors: Tod S. Heiles, Vancouver, WA (US); Hsue-Yang Liu, Vancourver, WA (US)

Correspondence Address: HEWLETT-PACKARD COMPANY, Intellectual Property Administration, P.O. Box 272400, Fort Collins, CO, 80527-2400, US

(21) Appl. No.: 09/964,316

(22) Filed: Sep. 26, 2001

(51) Int. Cl. B41J 3/42

(52) U.S. Cl. 347/19

(57) ABSTRACT

A single-pen, or multi-pen, printing device prints one or more diagnostic images to determine a print media line-feed advance offset to compensate for pen, or multi-pen, swath height and/or line-feed advance errors. A sensor detects pen swath optical densities from the diagnostic images, and an application component determines an error compensation factor from the pen swath optical densities. The sensor detects different pen swath optical densities from overlapping, aligned, and/or offset first and second print swath images that form a diagnostic image.

### TECHNICAL FIELD

This invention relates to printing devices and, in particular, to printing mechanism swath height and print media line-feed advance error compensation.

### BACKGROUND

An inkjet printer includes a printing assembly having pens, or cartridges as pens are commonly referred to, with one or more printheads to deposit ink onto a print media, such as paper. A pen printhead has an orifice plate that is formed with nozzles through which ink drops are “fired”, or otherwise ejected, onto the print media to form an image, such as text or a picture. The ink drops dry, or are heated to dry, on the print media shortly after deposition to form the printed image.

There are various types of inkjet printheads including, for example, thermal inkjet printheads and piezoelectric inkjet printheads. For a thermal inkjet printhead, ink droplets are ejected from individual nozzles by localized heating with a heating element located at individual nozzles. An electric current is applied to a heating element which causes a small volume of ink to be rapidly heated and vaporized. Once vaporized, the ink is ejected through the nozzle. A driver circuit is coupled to individual heating elements to provide the energy pulses and thereby controllably deposit ink drops from associated individual nozzles. The drivers are responsive to character generators and other image forming circuitry to energize selected nozzles of a printhead for forming images on the print media.

A conventional inkjet printer has a print unit that includes a reciprocating inkjet pen carriage system for travel back and forth across a print zone along an axis that spans a print media, or otherwise spans a printing width of the print media. The pen carriage system supports and positions a black pen for a typical one-color inkjet printer, or can be configured to support and position multiple pens, or cartridges, for a multi-color inkjet printer.

A reciprocating printing device can be configured for one-pass or multi-pass printing. For one-pass printing, the inkjet pen carriage system moves the inkjet pen, or pens, over the print media and the pen printheads deposit ink onto the print media in a print swath. A swath height of the print swath is defined by the dimensions of the printhead nozzles which deposit the ink to form an image on the print media. For example, a conventional printhead can be configured with an array of five hundred and twelve (512) nozzles which are spaced 1/600″ (1/600 of an inch) apart.

After printing a first swath, a line-feed advance mechanism of the inkjet printer advances the print media so that a second print swath can be printed beneath the first print swath. Ideally, the line-feed advance mechanism advances the print media a distance equal to one swath height plus 1/600″ such that the spacing between the ink deposited by the last nozzle of the first print swath and the ink deposited by the first nozzle of the second print swath is equal to the distance between the nozzles (i.e., 1/600″).

For multi-pass printing, such as two-pass printing, the inkjet pen carriage system moves the inkjet pen, or pens, over the print media and the pen printheads deposit ink onto the print media in a first print swath and a second print swath before advancing the print media. Typically, the total amount of ink to be deposited on the print media is divided evenly by the number of print passes. For example, fifty percent (50%) of the ink is deposited onto the print media during the first print swath and the other fifty percent (50%) of the ink is deposited onto the print media during the second print swath. Similarly, for four-pass printing, twenty-five percent (25%) of the ink is deposited onto the print media for each of the four print swaths.

A swath boundary occurs at the boundary of two print swaths. As described above, a swath boundary is created when a first swath is printed, the print media is advanced, and a second swath is printed beneath the first swath. An ideal swath boundary between the first and second print swaths is a distance equal to the spacing between the nozzles on the pen printhead (i.e., 1/600″).

Swath boundary banding is a significant print and/or image quality defect that occurs at a swath boundary between two print swaths which can be caused by a line-feed advance error relative to a printhead swath height. Swath boundary banding is visible in a printed image as too much space between print swaths (i.e., more than 1/600″), or as not enough space between the print swaths which appears as an overlap of the print swaths.

FIG. 1 illustrates variations of printer line-feed advances and pen swath heights relative to a first print swath 100 and a second print swath 102. Ideally, the first print swath 100 has a constant swath height 104, and the second print swath 102 has a constant swath height 106. A preferred printing result 108 illustrates a second swath 102 printed beneath a first swath 100 after the print media is advanced in a direction indicated by arrow 110. For the preferred printing result 108, there is no swath boundary banding between the first and second print swaths.

Printed image 112 illustrates the result of a line-feed advance mechanism that does not advance the print media far enough between print swaths. The first print swath 100 is printed within swath height region 104. However, the second print swath 102 overlaps the first print swath because the line-feed advance mechanism is not calibrated to advance the print media to a position where the second swath 102 is printed within swath height region 106. The second swath 102 overlaps the first swath 100 by approximately twenty (20) microns in region 114 which appears as a swath boundary band image defect.

Printed image 116 illustrates the result of a line-feed advance mechanism that advances the print media too far between print swaths. The first print swath 100 is printed within swath height region 104. However, a section 118 of the second print swath 102 is printed beyond the boundary of swath height region 106. The second swath 102 is printed approximately twenty (20) microns below the first swath 100 leaving a space in region 120 that appears as a swath boundary band image defect.

Printed image 122 illustrates the result of a positive print swath height error. The first print swath 100 extends beyond swath height region 104 at both ends of the print swath, such as section 124 of the print swath. Similarly, the second print swath 102 extends beyond swath height region 106 at both ends of the print swath, such as section 126 of the print swath. The first and second print swaths overlap by approximately twenty (20) microns in region 128 which appears as a swath boundary band image defect.

Printed image 130 illustrates the result of a negative print swath height error. The first print swath 100 is printed within swath height region 104, but does not extend to the region boundaries at both ends of the print swath. Similarly, the second print swath 102 is printed within swath height region 106, but does not extend to the region boundaries at both ends of the print swath. The second swath 102 is printed approximately twenty (20) microns below the first swath 100 leaving a space in region 132 that appears as a swath boundary band image defect.

Print media line-feed advance mechanisms in printing devices are calibrated during manufacture and before a printing device is available to an end-user. A line-feed advance distance is calibrated based on a pre-determined line-feed distance and any particular media handling system manufacturing defects that would cause a line-feed advance distance error. A line-feed distance is determined in part by a fixed pen swath height and characteristics of a media handling system drive roller, such as the drive roller diameter.

A pen swath height is considered a fixed variable when calibrating a line-feed advance distance for a particular printing device. Calibrating the line-feed advance distance does not, however, take into account any variations in pen swath heights that appear as swath boundary banding image defects between print swaths. As described above, the swath height for a pen in the particular printing device is defined by the dimensions of the pen's printhead nozzles which deposit the ink to form an image on a print media.

Media handling system manufacturing defects that would cause a line-feed advance distance error include, for example, media drive roller diameter errors that cause roller runout. Roller runout concerns an eccentricity of a roller, such as a camber effect for example, that would change the relationship between the angular motion of the roller and the media line-feed advance distance. Such a roller offset would translate to a longer media advance distance at one roller position, and to a shorter media advance distance at a second roller position.

Calibrating the media line-feed advance distance for a particular printing device during manufacture does not account for pen swath height errors and line-feed errors that develop when the printing device is in use. For example, media line-feed advance errors can develop over time as components are worn with use or when replacing a print media drive roller that has a slightly larger or smaller diameter than the original roller which was the basis for the calibrated line-feed advance distance.

Although pen swath heights are considered a fixed variable when calibrating a particular printing device, a pen swath height is also susceptible to variations that cause printed and/or image quality defects. For example, a pen swath height can vary over time with use of the pen or when replacing a pen, or cartridge. Due to manufacturing variances, a replacement pen can have a print swath height that is different from the pen being replaced.

Other variations that cause errors in a pen swath height include printhead nozzle spacing which can be varied over time when cleaning the printhead with a printing device service station. Additionally, the distance between the printhead nozzles and the print media, which is typically one millimeter, can be varied by the thickness of the print media, and/or the ink drops may spread out or be compressed depending upon the type of print media which can lengthen or shorten a swath height.

Pen swath height and line-feed advance distance errors cause swath boundary banding image defects which are visible and degrade the quality of a printed image.

### SUMMARY

A single-pen, or multi-pen, printing device prints one or more diagnostic images to determine a print media line-feed advance offset to compensate for pen, or multi-pen, swath height and/or line-feed advance errors. A sensor, such as an optical sensor, detects pen swath optical densities from the diagnostic images, and an application component determines an error compensation factor from the pen swath optical densities. The sensor detects different pen swath optical densities from overlapping, aligned, and/or offset first and second print swath images that form a diagnostic image. The application component can determine the offset error compensation factor from the average of multiple pen swath optical densities, and/or can determine an optimal offset error compensation for multiple pens of a particular printing device.

### BRIEF DESCRIPTION OF THE DRAWINGS

The same numbers are used throughout the drawings to reference like features and components.

FIG. 1 illustrates variations of printer line-feed advances and pen swath heights.

FIG. 2 is block diagram that illustrates various components of an exemplary printing device.

FIG. 3 illustrates various components of an exemplary printing device from a front-view.

FIG. 4 illustrates the various components of the exemplary printing device shown in FIG. 3 from a top-view.

FIG. 5 illustrates printed diagnostic patterns used to determine pen swath optical densities at corresponding printer line-feed offset factors.

FIG. 6 illustrates printed diagnostic patterns used to determine pen swath optical densities at corresponding printer line-feed offset factors.

FIG. 7 is a pen swath height error compensation chart for a first pen that illustrates printer line-feed advance offset calibration factors versus an inverse of optical density.

FIG. 8 is a pen swath height error compensation chart for a second pen that illustrates printer line-feed advance offset calibration factors versus an inverse of optical density.

FIG. 9 is a swath height error compensation chart that illustrates printer line-feed offset calibration factors versus an inverse of optical density for an average of the first printer pen swath height error compensation shown in FIG. 7 and the second printer pen swath height error compensation shown in FIG. 8.

FIG. 10 is a swath height error compensation chart that illustrates an adjusted printer line-feed offset calibration factor versus an inverse of optical density for the average swath height error compensation shown in FIG. 9.

FIG. 11 is a flow diagram that describes a method for determining a printing device line-feed advance offset corresponding to a pen swath height and/or line-feed error compensation factor.

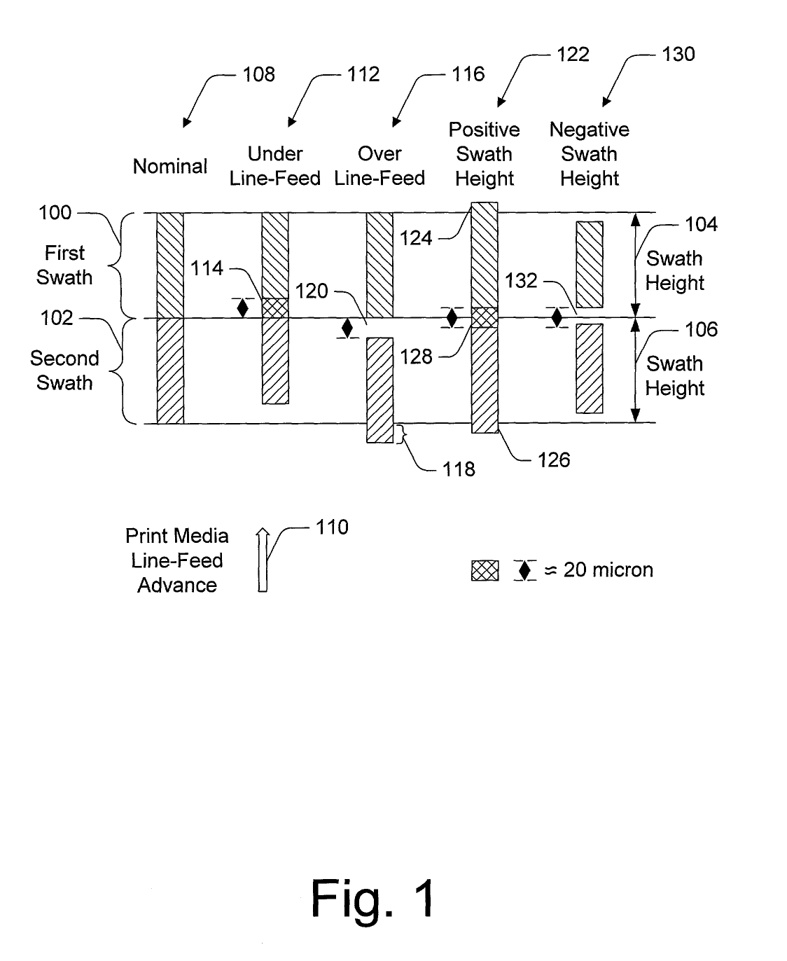

### DETAILED DESCRIPTION

Introduction

The following describes systems and methods to measure a printing mechanism swath height utilizing an overlap measurement technique, and to calibrate a printing device line-feed advance distance according to determined pen swath height and line-feed advance errors causing swath boundary banding image defects. Calibrating the line-feed advance distance in a printing device accounts for the combined effect of both line-feed advance errors and pen, or multi-pen, swath height errors.

Exemplary Printer Architecture

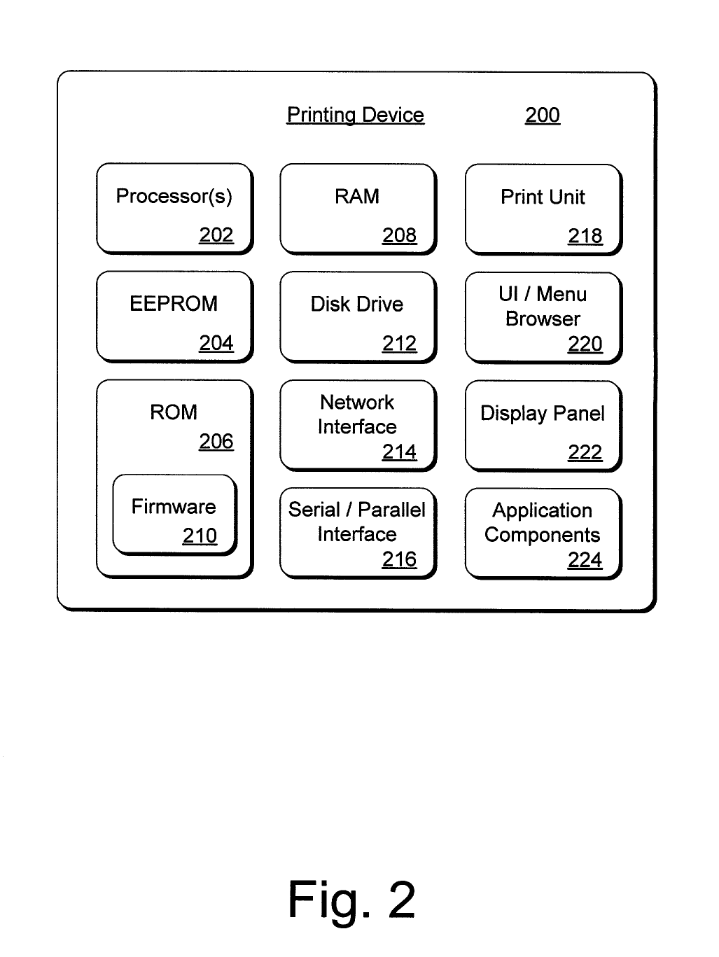

FIG. 2 illustrates various components of an exemplary printing device 200 that can be utilized to implement the inventive techniques described herein. Printer 200 includes one or more processors 202, an electrically erasable programmable read-only memory (EEPROM) 204, ROM 206 (non-erasable), and a random access memory (RAM) 208. Although printer 200 is illustrated having an EEPROM 204 and ROM 206, a particular printer may only include one of the memory components. Additionally, although not shown, a system bus typically connects the various components within printing device 200.

Printer 200 includes a firmware component 210 that is implemented as a permanent memory module stored on ROM 206. Firmware 210 is programmed and tested like software, and is distributed with printer 200. Firmware 210 can be implemented to coordinate operations of the hardware within printer 200 and contains programming constructs used to perform such operations.

Processor(s) 202 process various instructions to control the operation of printer 200 and to communicate with other electronic and computing devices. The memory components, EEPROM 204, ROM 206, and RAM 208, store various information and/or data such as configuration information, fonts, templates, data being printed, and menu structure information. Although not shown, a particular printer can also include a flash memory device in place of or in addition to EEPROM 204 and ROM 206.

Printer 200 also includes a disk drive 212, a network interface 214, and a serial/parallel interface 216. Disk drive 212 provides additional storage for data being printed or other information maintained by printer 200. Although printer 200 is illustrated having both RAM 208 and a disk drive 212, a particular printer may include either RAM 208 or disk drive 212, depending on the storage needs of the printer. For example, an inexpensive printer may include a small amount of RAM 208 and no disk drive 212, thereby reducing the manufacturing cost of the printer.

Network interface 214 provides a connection between printer 200 and a data communication network. Network interface 214 allows devices coupled to a common data communication network to send print jobs, menu data, and other information to printer 200 via the network. Similarly, serial/parallel interface 216 provides a data communication path directly between printer 200 and another electronic or computing device. Although printer 200 is illustrated having a network interface 214 and serial/parallel interface 216, a particular printer may only include one interface component.

Printer 200 also includes a print unit 218 that includes mechanisms arranged to selectively apply an imaging medium such as liquid ink, toner, and the like to a print media in accordance with print data corresponding to a print job. Print media can include any form of media used for printing such as paper, plastic, fabric, Mylar, transparencies, and the like, and different sizes and types such as 8½×11, A4, roll feed media, etc. For example, print unit 218 can include an inkjet printing mechanism that selectively causes ink to be applied to a print media in a controlled fashion. Ink deposited on a print media can be more permanently fixed to the print media, for example, by selectively applying conductive or radiant thermal energy to the ink. Those skilled in the art will recognize that there are many different types of print units available, and that for the purposes of the present invention, print unit 218 can include any of these different types.

Printer 200 also includes a user interface and menu browser 220, and a display panel 222. The user interface and menu browser 220 allows a user of the printer 200 to navigate the printer's menu structure. User interface 220 can be indicators or a series of buttons, switches, or other selectable controls that are manipulated by a user of the printer. Display panel 222 is a graphical display that provides information regarding the status of printer 200 and the current options available to a user through the menu structure.

Printer 200 can, and typically does include application components 224 that provide a runtime environment in which software applications or applets can run or execute. Those skilled in the art will recognize that there are many different types of runtime environments available. A runtime environment facilitates the extensibility of printer 200 by allowing various interfaces to be defined that, in turn, allow application components 224 to interact with the printer.

General reference is made herein to one or more printing devices, such as printing device 200. As used herein, “printing device” means any electronic device having data communications, data storage capabilities, and/or functions to render printed characters and images on a print media. A printing device may be a printer, fax machine, copier, plotter, and the like. The term “printer” includes any type of printing device using a transferred imaging medium, such as ejected ink, to create an image on a print media. Examples of such a printer can include, but are not limited to, inkjet printers, plotters, portable printing devices, as well as multi-function combination devices. Although specific examples may refer to one or more of these printers, such examples are not meant to limit the scope of the claims or the description, but are meant to provide a specific understanding of the described implementations.

Exemplary Inkjet Printing Device

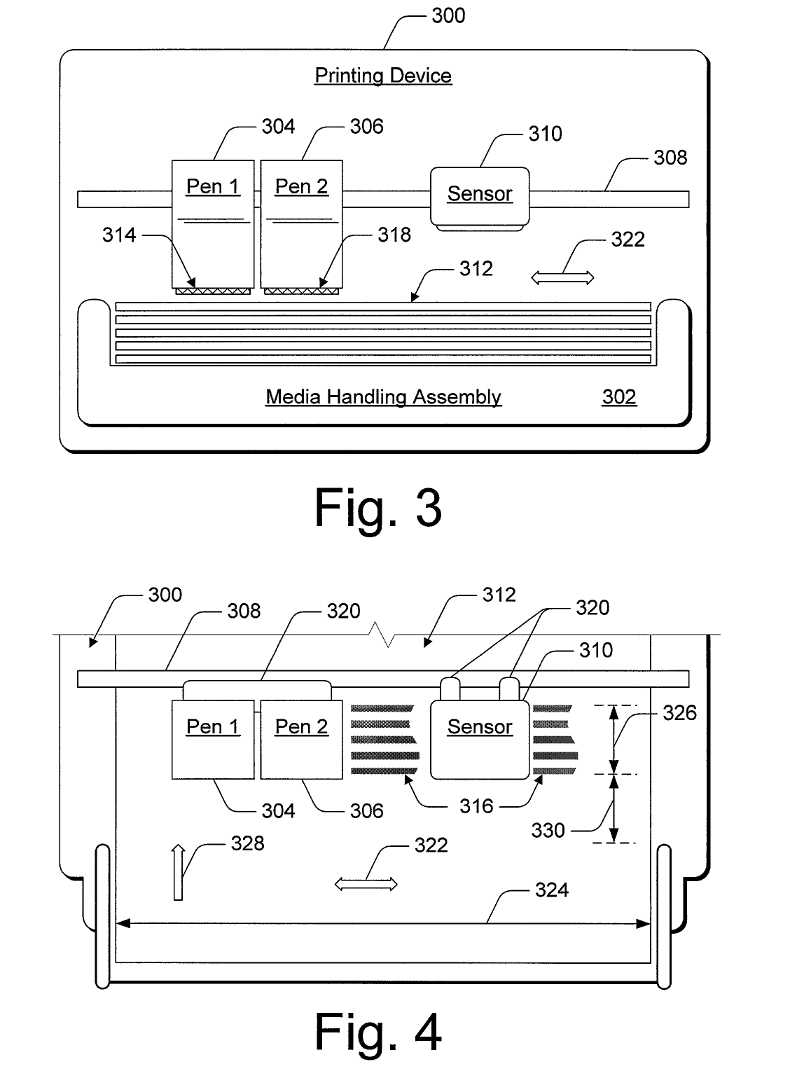

FIGS. 3 and 4 illustrate a printing device 300 that can include one or more of the components of exemplary printing device 200 (FIG. 2). The exemplary printing device is described in the environment and context of an inkjet printing device. While it is apparent that printing device components vary from one device to the next, those skilled in the art will recognize the applicability of the present invention to printing devices in general.

FIG. 3 illustrates a front-view of printing device 300, and FIG. 4 illustrates a top-view of printing device 300. Exemplary printing device 300 includes a media handling assembly 302, a first pen 304, and a second pen 306.

An inkjet printer pen is also commonly referred to as a “cartridge”. Printing device 300 also includes a pen carriage mechanism 308 and a sensor 310, such as an optical sensor to detect the optical density of a printed image. An example of an inkjet printer having a reciprocating inkjet pen carriage system for travel back and forth along an axis that spans a print media, or otherwise spans a printing width, is described in U.S. Pat. No. 5,774,140.

Media handling assembly 302 holds print media 312 and routes it through printing device 300 for printing. The physical path of the print media through a printer is typically referred to as the “print path” or “print media path”. Media handling assembly 302 includes components to route print media 312 through printing device 200. The components can include any combination of belts, pulleys, media drive rollers, and a motor drive unit, or units (components not shown). Those skilled in the art will recognize that there are any number of media handling assembly configurations and components that can be implemented in any number of printing devices to route print media through a printing device.

First pen 304 has a printhead 314, or printheads, to deposit an imaging medium, such as ink, onto print media 312 to form a print swath 316 in response to printing device 300 receiving print data corresponding to a print job. Similarly, second pen 306 has a printhead 318, or printheads, to deposit the imaging medium onto print media 312. Conventionally, an inkjet pen or cartridge includes an ink reservoir to store a supply of ink and electrical connectors to receive printing control signals from one or more printing device processors. Although printing device 300 only has two pens, those skilled in the art will recognize that a printing device can include any number of pens or cartridges having varying ink colors, such as for color inkjet printers.

Pen carriage mechanism 308 includes framework components 320 to support pens 304 and 306, and sensor 310 in printing device 300, and a motor drive unit (not shown) to drive the pens and sensor back and forth in directions indicated by arrows 322 across a width 324 of print media 312. Those skilled in the art will recognize that any number of pen carriage mechanisms and framework components can be implemented in any number of printing devices to support and drive a sensor component and one or more pens, or cartridges, in a printing device.

Pen carriage mechanism 308 moves pens 304 and 306 over print media 312 and the pen printheads 314 and 318 deposit ink onto the print media to form print swath 316. A swath height 326 of print swath 316 is defined by the dimensions of the printhead nozzles which deposit the ink to form print swath 316. After printing a first swath 316, a media handling assembly line-feed advance mechanism advances print media 312 in a direction indicated by arrow 328 so that a second print swath having a swath height 330 can be printed beneath the first print swath 316.

Sensor 310 can be implemented as an optical sensor to detect the optical density of a printed image, such as print swath 316. Pen carriage mechanism 308 moves sensor 310 over print swath 316 in directions indicated by arrows 322 across a width 324 of print media 312. Sensor 310 generates an electrical signal that is processed by a software component, such as application component 224 (FIG. 2). Those skilled in the art will recognize that sensor 310 can be implemented with any number of sensors of varying resolutions and fields of view in any number of printing devices. Additionally, although shown as an independent component in printing device 300, sensor 310 can be configured and/or integrated with first pen 304, with second pen 306, or with other components in printing device 300.

Detection of Pen Swath Boundary Optical Densities

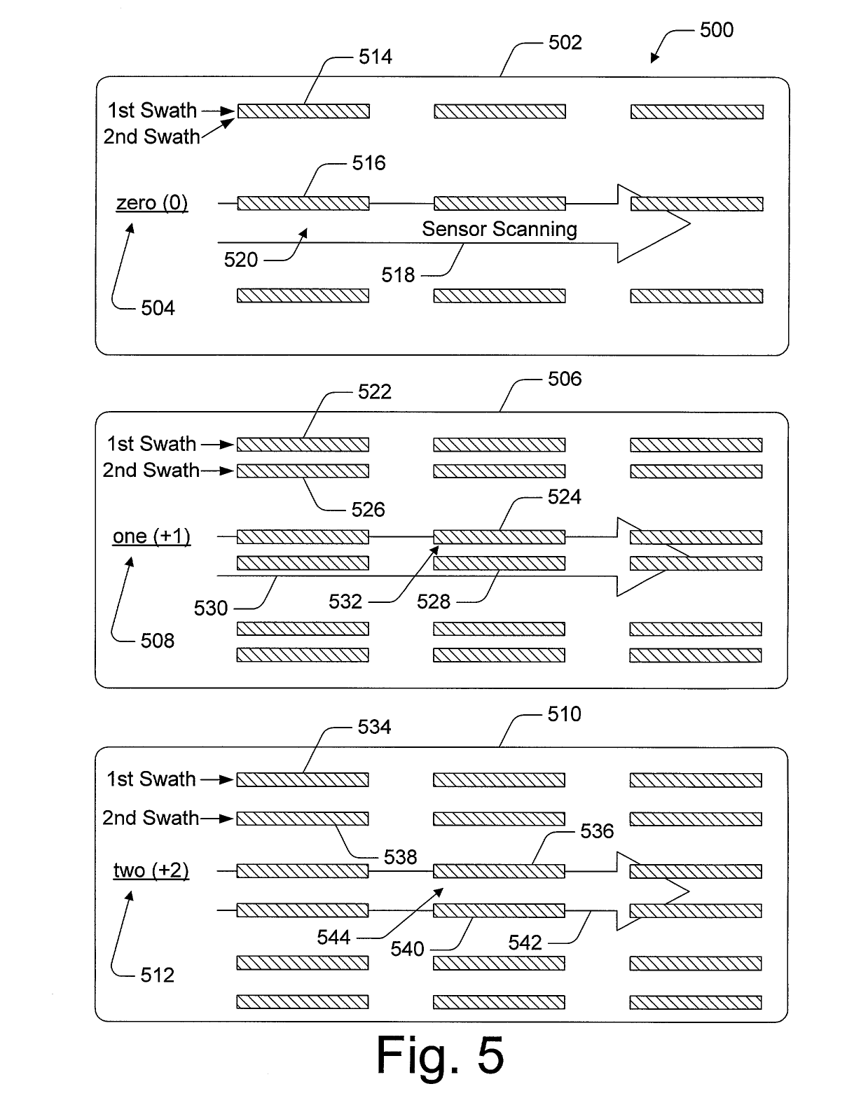

FIG. 5 illustrates a set of printed diagnostic images 500 that are printed with a printing device pen to determine pen swath optical densities at corresponding print media line-feed advance offsets. Diagnostic image 502 is printed at a line-feed advance offset 504 of zero (0). The same printing device pen, such as first pen 304 in exemplary printing device 300 (FIG. 3), also prints diagnostic image 506 which is printed at a line-feed advance offset 508 of positive one (+1), and prints diagnostic image 510 which is printed at a line-feed offset 512 of positive two (+2).

In diagnostic image 502, a first print swath is printed as horizontal image lines, such as lines 514, 516, and the other horizontal lines of the diagnostic image when a calibration procedure of the printing device is initiated. At the line-feed advance offset 504 of zero (0), the printing device line-feed advance mechanism does not advance the print media before the second print swath is printed as a second set of horizontal lines. In diagnostic image 502, the second print swath horizontal lines directly overlap the first print swath horizontal lines.

After the first and second print swaths are printed, an optical sensor, such as sensor 310 in exemplary printing device 300 (FIG. 3), scans in a direction 518 over the print media and detects pen swath optical densities from the printed diagnostic image 502. For example, sensor 310 detects a pen swath optical density for horizontal line 516 along with white space 520.

A detected optical density is determined to be a high optical density for a darker region, such as a region having more print swaths and less white space. Conversely, a detected optical density is determined to be a low optical density for a lighter region, such as a region having less printed image and more white space. An inverse of optical density, or one over optical density (1/OD), is a “lightness” factor. Accordingly, a lighter region determined to be of low optical density has a higher lightness factor than a darker region determined to be of high optical density.

In diagnostic image 506, a first print swath is printed as horizontal image lines, such as lines 522, 524, and the other, corresponding first print swath horizontal lines of the diagnostic image. At the line-feed advance offset 508 of positive one (+1), the printing device line-feed advance mechanism advances the print media by a factor of one, which is 1/600″ to correlate with the spacing between pen printhead nozzles. The second print swath is printed as a second set of horizontal lines, such as lines 526, 528, and the other corresponding second print swath horizontal lines of the diagnostic image. In diagnostic image 506, the second print swath horizontal lines are printed just beneath corresponding first print swath horizontal lines.

After the first and second print swaths are printed, the optical sensor scans in a direction 530 over the print media and detects pen swath optical densities from printed diagnostic image 506. For example, sensor 310 detects a pen swath optical density for horizontal lines 524 (first print swath) and 528 (second print swath) along with white space 532.

In diagnostic image 510, a first print swath is printed as horizontal image lines, such as lines 534, 536, and the other corresponding first print swath horizontal lines of the diagnostic image. At the line-feed advance offset 512 of positive two (+2), the printing device line-feed advance mechanism advances the print media by a factor of two, which is 2/600″ to correlate with a factor of the spacing between pen printhead nozzles. The second print swath is printed as a second set of horizontal lines, such as lines 538, 540, and the other corresponding second print swath horizontal lines of the diagnostic image. In diagnostic image 510, the second print swath horizontal lines are printed farther beneath the corresponding first print swath horizontal lines than the second print swath horizontal lines in diagnostic image 506.

After the first and second print swaths are printed, the optical sensor scans in a direction 542 over the print media and detects pen swath optical densities from the printed diagnostic image 510. For example, sensor 310 detects a pen swath optical density for horizontal lines 536 (first print swath) and 540 (second print swath) along with white space 544.

The detected optical density of horizontal line 516 and white space 520 in diagnostic image 502 is determined to be the lightest region and of the lowest optical density because it has the most white space and only one-half of horizontal line 516 is scanned with the sensor. The detected optical density of horizontal lines 536, 540, and white space 544 in diagnostic image 510 is determined to be the second-lightest region and of a higher optical density because one-half of each horizontal line 536 and 540 is scanned with the sensor. Of the three detected optical density regions, the detected optical density of horizontal lines 524, 528, and white space 532 in diagnostic image 506 is determined to be the darkest region and of the highest optical density because it has the least white space and one-half of line 524 and all of line 540 is scanned with the sensor.

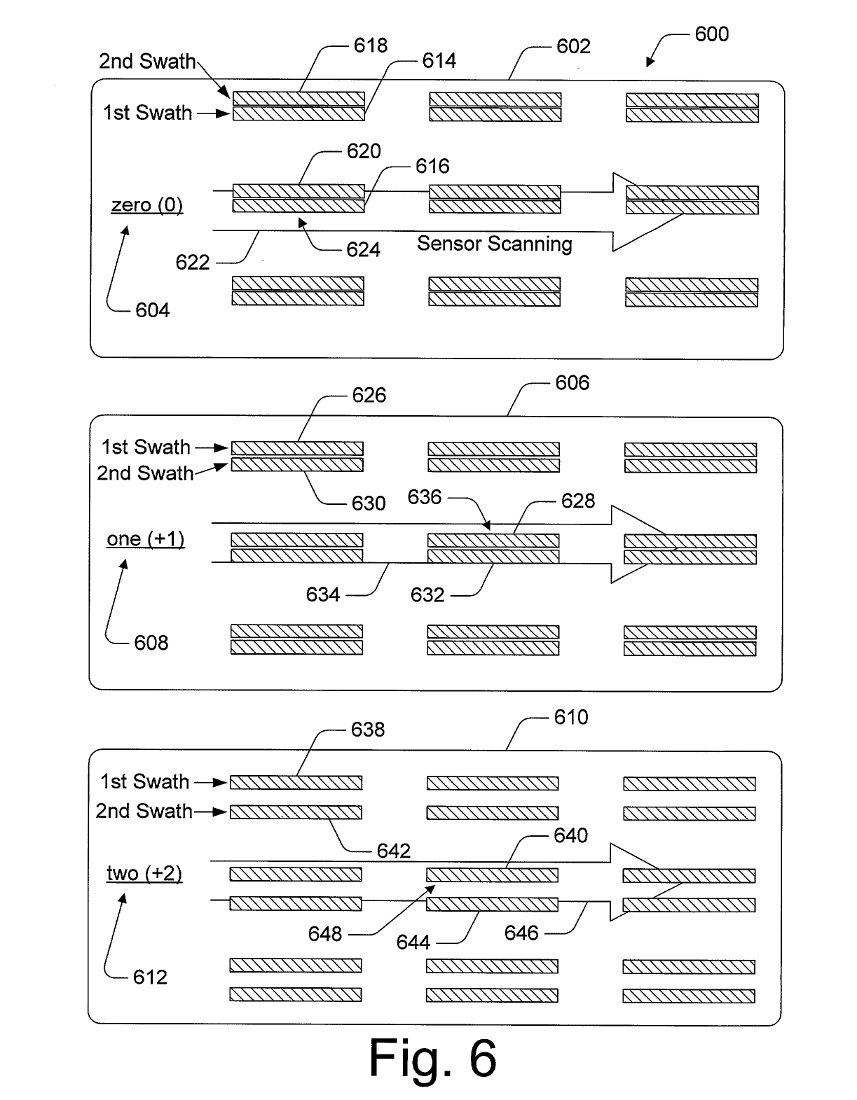

FIG. 6 illustrates a second set of printed diagnostic images 600 that are printed with a printing device pen to determine pen swath optical densities at corresponding print media line-feed advance offsets. Diagnostic image 602 is printed at a line-feed advance offset 604 of zero (0). The same printing device pen, such as second pen 306 in exemplary printing device 300 (FIG. 3), also prints diagnostic image 606 which is printed at a line-feed advance offset 608 of positive one (+1), and prints diagnostic image 610 which is printed at a linefeed offset 612 of positive two (+2).

In diagnostic image 602, a first print swath is printed as horizontal image lines, such as lines 614, 616, and the other horizontal lines of the diagnostic image when a calibration procedure of the printing device is initiated. At the line-feed advance offset 604 of zero (0), the printing device line-feed advance mechanism does not advance the print media before the second print swath is printed as a second set of horizontal lines. The second print swath is printed as the second set of horizontal lines, such as lines 618, 620, and the other corresponding second print swath horizontal lines of the diagnostic image. In diagnostic image 602, the second print swath horizontal lines are printed just above corresponding first print swath horizontal lines.

After the first and second print swaths are printed, an optical sensor, such as sensor 310 in exemplary printing device 300 (FIG. 3), scans in a direction 622 over the print media and detects second pen swath optical densities from the printed diagnostic image 602. For example, sensor 310 detects a pen swath optical density for horizontal line 616 (first print swath) and 620 (second print swath) along with white space 624.

In diagnostic image 606, a first print swath is printed as horizontal image lines, such as lines 626, 628, and the other corresponding first print swath horizontal lines of the diagnostic image. At the line-feed advance offset 608 of positive one (+1), the printing device line-feed advance mechanism advances the print media by a factor of one, which is 1/600″ to correlate with the spacing between pen printhead nozzles. The second print swath prints a second set of horizontal lines, such as lines 630, 632, and the other corresponding second print swath horizontal lines of the diagnostic image. In diagnostic image 606, the second print swath horizontal lines are printed just beneath corresponding first print swath horizontal lines.

After the first and second print swaths are printed, the optical sensor scans in a direction 634 over the print media and detects second pen swath optical densities from the printed diagnostic image 606. For example, sensor 310 detects a pen swath optical density for horizontal lines 628 (first print swath) and 632 (second print swath) along with white space 636.

In diagnostic image 610, a first print swath is printed as horizontal image lines, such as lines 638, 640, and the other corresponding first print swath horizontal lines of the diagnostic image. At the line-feed advance offset 612 of positive two (+2), the printing device line-feed advance mechanism advances the print media by a factor of two, which is 2/600″ to correlate with a factor of the spacing between pen printhead nozzles. The second print swath is printed as a second set of horizontal lines, such as lines 642, 644, and the other corresponding second print swath horizontal lines of the diagnostic image. In diagnostic image 610, the second print swath horizontal lines are printed farther beneath the corresponding first print swath horizontal lines than the second print swath horizontal lines in diagnostic image 606.

After the first and second print swaths are printed, the optical sensor scans in a direction 646 over the print media and detects pen swath optical densities from the printed diagnostic image 610. For example, sensor 310 detects a pen swath optical density for horizontal lines 640 (first print swath) and 644 (second print swath) along with white space 648.

The detected optical density of horizontal lines 616, 620, and white space 624 in diagnostic image 602, and the detected optical density of horizontal lines 640, 644, and white space 648 in diagnostic image 610 are determined to be the lightest regions and of the lowest optical density because they have the most white space and because one-half of line 620 and all of line 616 is scanned with the sensor. Of the three detected optical density regions, the detected optical density of horizontal lines 628, 632, and white space 636 in diagnostic image 606 is determined to be the darkest region and of the highest optical density because it has the least white space and two horizontal images are scanned with the sensor.

Exemplary Pen Swath Height Error Compensation

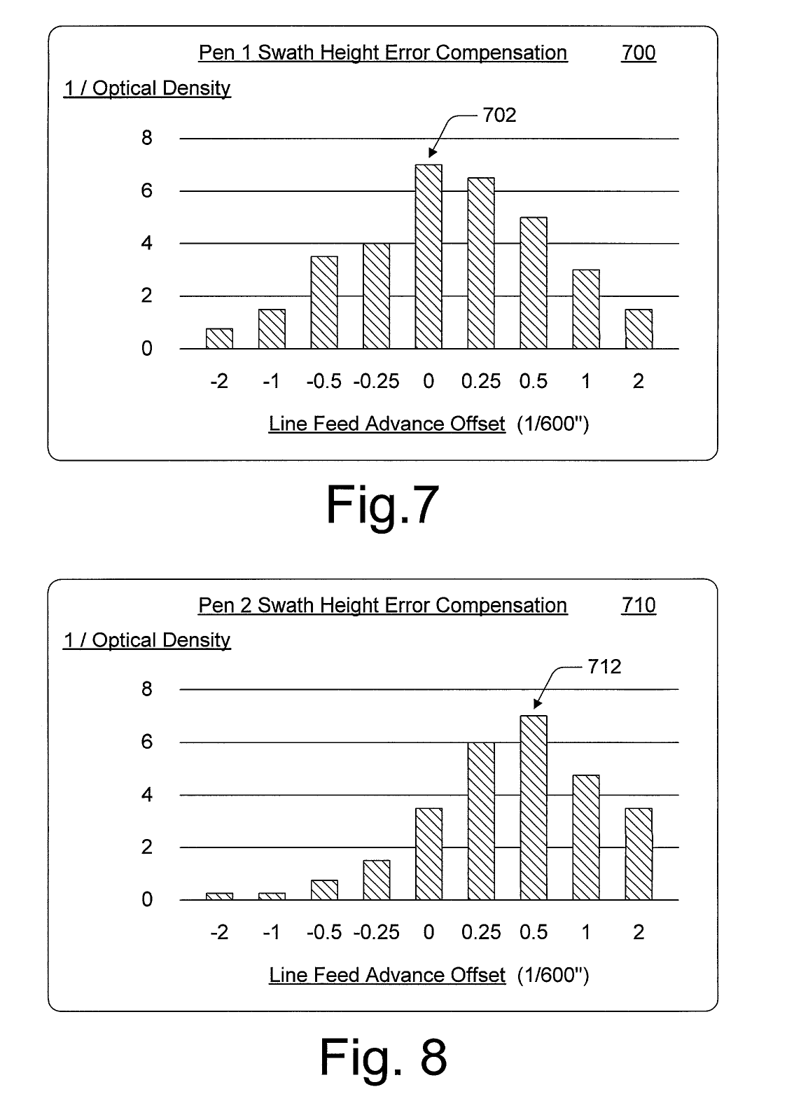

FIG. 7 illustrates a pen swath height error compensation chart 700 that charts line-feed advance offsets versus an inverse of optical density for a first printing device pen, such as first pen 304 in exemplary printing device 300 (FIG. 3). As described above, an inverse of optical density, or one over optical density (1/OD), is a “lightness” factor. Accordingly, a lighter region determined to be of low optical density has a higher lightness factor than a darker region determined to be of high optical density.

Chart 700 shows that an optimal pen swath height error compensation 702 correlates to a line-feed advance offset of zero (0). Chart 700 roughly correlates with the pen swath optical densities determined from the printed diagnostic images 500 (FIG. 5). The scanned region in diagnostic image 502 is the lightest region and of the lowest optical density because it has the most white space and the least of a printed horizontal image (i.e., line 516). The scanned region in diagnostic image 502 is the lightest region because the second print swath is printed directly over the first print swath, indicating that at the line-feed advance offset 504 of zero (0), no pen swath height compensation is required.

It is to be appreciated that, although only three diagnostic images 502, 506, and 510 (FIG. 5) are shown at line-feed advance offsets 504, 508, and 512, respectively, any number of diagnostic images at varying line-feed advance offsets can be printed to calibrate a printing device for pen swath height and line-feed advance errors. For example, pen swath height error compensation chart 700 (FIG. 7) shows that pen swath optical densities are determined at line-feed advance offset factors ranging from negative two (−2) to positive two (+2) of 1/600″. Furthermore, chart 700 represents an average of multiple pen swath optical densities for a given line-feed advance offset.

It is also to be appreciated that more than two print swaths for each diagnostic image can be printed for a greater sensor scanning resolution and a more precise calibration determination. For example, several pairs of print swaths can be printed with a line-feed advance offset that is less than the width of a one nozzle row, or dotrow, to form a diagnostic image. Printing the horizontal images at small line-feed advance increments increases the calibration precision and accuracy. Those skilled in the art will also recognize that the detectable optical density of a print swath, which translates to an electronic signal, can be enhanced with any combination of overlapping or interleaving print swaths and/or any combinations of varying colors, patterns, and shapes of the print swaths. Although the print swaths described in reference to FIGS. 5 and 6 are horizontal line images, the print swaths can be of any color, pattern, or shape to enhance the detectable signal characteristics of the print swath optical densities.

FIG. 8 illustrates a pen swath height error compensation chart 710 that charts line-feed advance offsets versus an inverse of optical density for a second printing device pen, such as second pen 306 in exemplary printing device 300 (FIG. 3). Chart 710 shows that an optimal pen swath height error compensation 712 correlates to a line-feed advance offset of positive one-half (+0.5). Chart 710 roughly correlates with the pen swath optical densities determined from the printed diagnostic images 600 (FIG. 6). Diagnostic image 602 illustrates that, at line-feed advance offset 604 of (0), the second print swath 618 is printed above the first print swath 614, indicating a pen swath height error. Diagnostic image 606 illustrates that, at line-feed advance offset 608 of positive one (+1), the second print swath 630 is printed beneath the first print swath 626. Chart 710 shows that the optimal pen swath height error compensation factor for the pen swath height error is between a line-feed advance offset of zero (0) and positive one (+1), which is positive one-half (+0.5).

As with chart 700 (FIG. 7), it is to be appreciated that chart 710 (FIG. 8) shows that pen swath optical densities can be determined at any number of varying line-feed advance offset factors, such as from negative two (−2) to positive two (+2) of 1/600″, and not just at the three diagnostic images 602, 606, and 610 (FIG. 6). Furthermore, chart 710 represents an average of multiple pen swath optical densities for a given line-feed advance offset.

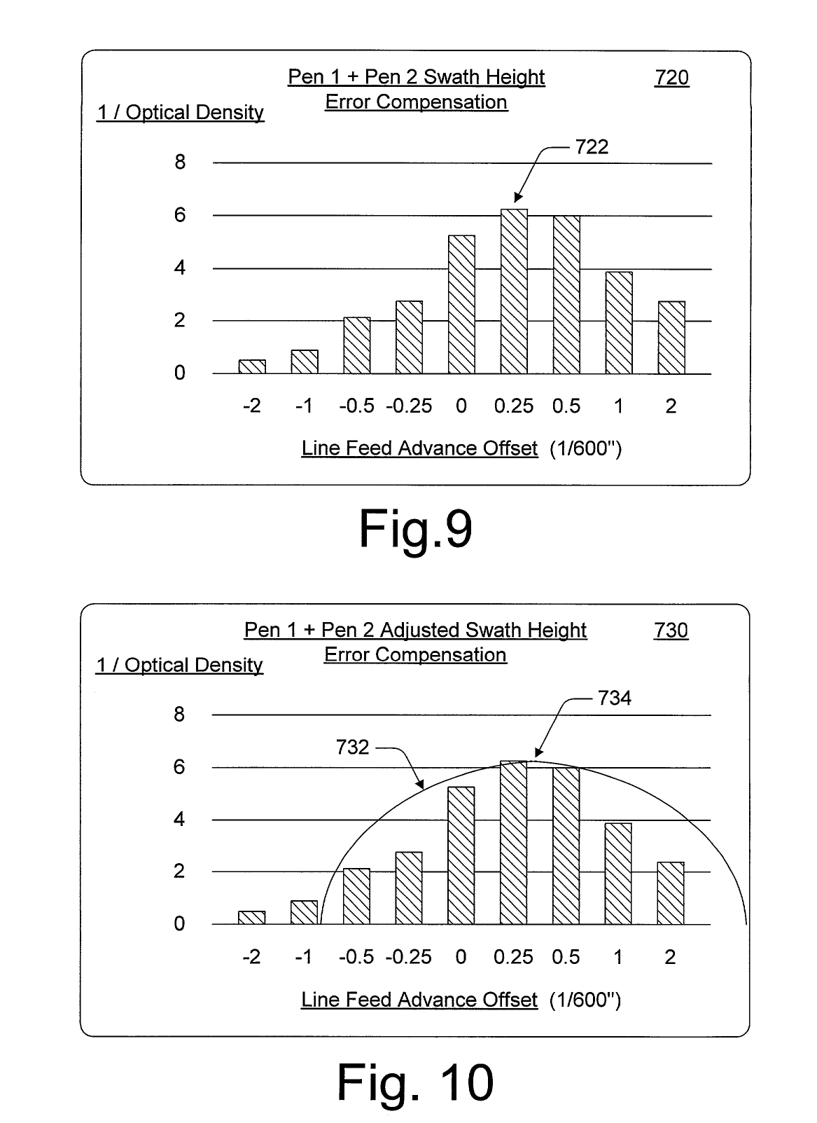

FIG. 9 illustrates a swath height error compensation chart 720 that charts line-feed advance offsets versus an inverse of optical density for an average of the first printer pen swath height error compensation shown in FIG. 7 and the second printer pen swath height error compensation shown in FIG. 8. For a multi-pen printing device, such as printing device 300 having a first pen 304 and a second pen 306 (FIG. 3), an average of the multiple pens' optimal linefeed advance offset can be determined to correct for multiple pen swath height errors. This provides the best overall pen swath height error compensation result for the multiple pens of a particular printing device.

Chart 720 shows that an average swath height error compensation 722 correlates to a line-feed advance offset of positive one-quarter (+0.25) which corresponds to an average of the first pen optimal line-feed advance offset 702 of zero (0) (FIG. 7) and the second pen optimal line-feed advance offset 712 of positive one-half (+0.5) (FIG. 8).

FIG. 10 illustrates a swath height error compensation chart 730 that shows an adjusted printer line-feed advance offset versus an inverse of optical density for the average multi-pen swath height error compensation 722 shown in FIG. 9. Chart 730 shows that the average multi-pen swath height error compensation is adjusted with a best-fit curve 732, and that an adjusted average swath height error compensation 734 correlates to a line-feed advance offset of approximately plus three-eighths (+0.375) of 1/600″.

Those skilled in the art will recognize that other compensation, or “best-fit”, techniques can be applied to pen swath height error compensation factors to achieve the best overall compensation result for multiple pens of a particular printing device. For example, each of the multiple pens can be evaluated according to a weighted visibility factor corresponding to pen colors that are used most often. Black can be weighted more because it is the darkest color and would show more of a swath boundary banding error on a white print media. Similarly, yellow can be weighted the least because it is the lighter color. An example of weighted visibility factors is black=5, cyan=2, magenta=2, and yellow=1. Thus, a determined line-feed advance offset would also take into account pen color and visibility factors.

The multiple pens of a multi-pen printing device can also be evaluated according to a weighted usage factor corresponding to which pen, or pens, will be used to deposit an imaging medium forming a print swath on a print media. For example, if an image will be printed with black and yellow only, then the black pen can be allocated a usage factor of sixty-six percent (66%) and the yellow pen can be allocated a usage factor of thirty-four percent (34%). Those skilled in the art will recognize that the multiple pens can also be weighted with a combination of a visibility factor and a usage factor, or weighted with other well-known techniques.

Methods for Pen Swath Height and Line-Feed Error Compensation

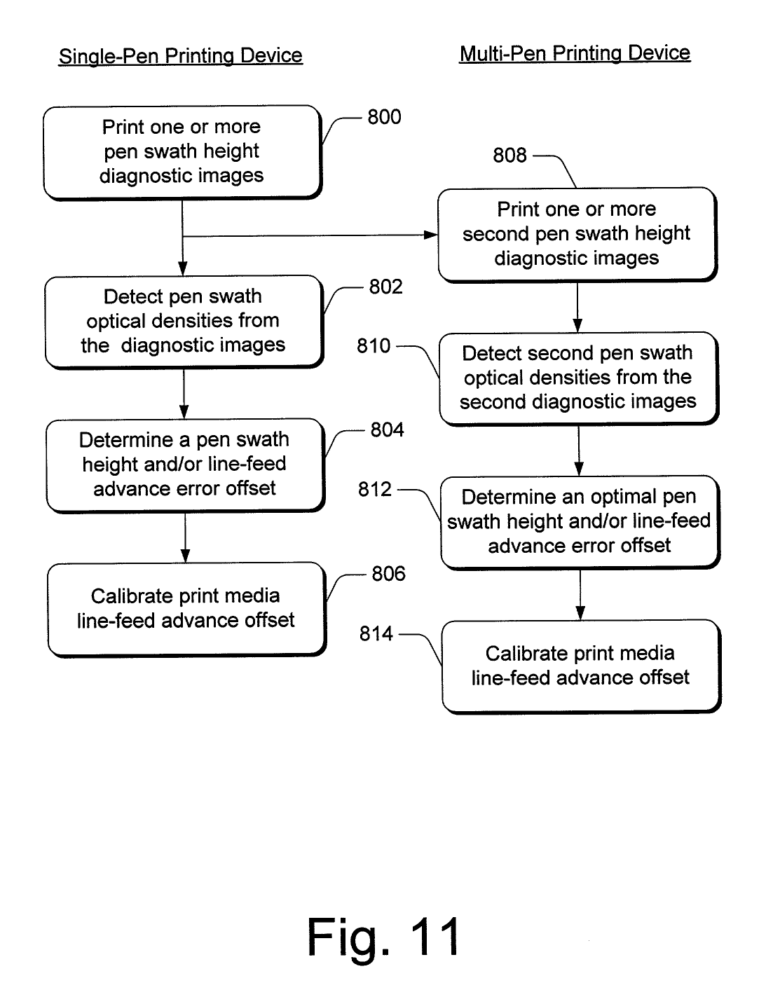

FIG. 11 illustrates a method for determining a printing device line-feed advance offset corresponding to a determined pen swath height and/or line-feed error compensation. The order in which the method is described is not intended to be construed as a limitation. Furthermore, the method can be implemented in any suitable hardware, software, firmware, or combination thereof. In addition, the method can be implemented by one or more processors executing instructions that are maintained on a computer-readable media.

At block 800, one or more sets of pen swath height diagnostic images are printed on a print media. The diagnostic images can include first print swath images and second print swath images as shown in FIGS. 5 and 6. Printing the swath images with a first pen includes printing the first swath images on the print media, advancing the print media, and printing the second swath images.

At block 802, pen swath optical densities are detected from the diagnostic images. Detecting the pen swath optical densities includes detecting different pen swath optical densities from overlapping, offset, or aligned first swath images and corresponding second swath images.

At block 804, a pen swath height and/or line-feed advance error offset is determined from the pen swath optical densities. Determining the error offset includes averaging multiple pen swath optical densities. At block 806, a print media line-feed advance is offset, or calibrated, corresponding to the determined pen swath height and/or line-feed advance error offset.

At block 808, second sets of pen swath height diagnostic images are printed on a print media with a second pen in a multi-pen printing device. The diagnostic images can include first print swath images and second print swath images. Printing the swath images with a second pen includes printing the first swath images on the print media, advancing the print media, and printing the second swath images.

At block 810, second pen swath optical densities are detected from the second diagnostic images. Detecting the second pen swath optical densities includes detecting different second pen swath optical densities from overlapping, offset, or an alignment of first swath images and corresponding second swath images.

At block 812, a pen swath height and/or line-feed advance error offset is determined from the first pen swath optical densities and the second pen swath optical densities. Determining the error offset includes averaging multiple pen swath optical densities, determining an optimal error offset, or selecting a lowest optical density value from the detected optical densities. At block 814, a print media line-feed advance is offset, or calibrated, corresponding to the determined pen swath height and/or line-feed advance error offset.

Conclusion

The pen swath height overlap measurement technique provides a printing device line-feed advance offset that accounts for the combined effect of both line-feed advance errors and pen, or multi-pen, swath height errors which cause swath boundary banding image defects. Additionally, the printing device line-feed advance can be calibrated by a user of the device to compensate for component wear over time, and component replacement that may vary the optimal print media line-feed advance distance.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A printing device, comprising:
a pen configured to transfer an imaging medium onto a print media to form a printed diagnostic image;
a sensor configured to detect pen swath optical densities from the printed diagnostic image;
an application component configured to determine a pen swath height error compensation factor from the pen swath optical densities; and
a print media line-feed advance offset configured to be calibrated corresponding to the pen swath height error compensation factor.

2. A printing device as recited in claim 1, wherein the pen is further configured to transfer the imaging medium onto the print media to form multiple sets of printed diagnostic images, and wherein the sensor is further configured to detect the pen swath optical densities from the multiple sets of printed diagnostic images.

3. A printing device as recited in claim 1, wherein the pen is further configured to form the printed diagnostic image with first swath images and at least second swath images.

4. A printing device as recited in claim 1, wherein the pen is further configured to form the printed diagnostic image with overlapping print swath images.

5. A printing device as recited in claim 1, wherein the sensor is further configured to detect pen swath optical densities from multiple sets of print swath images that form the printed diagnostic image, each set of print swath images printed at a different print media line-feed advance offset.

6. A printing device as recited in claim 1, wherein the sensor is further configured to detect pen swath optical densities from multiple sets of print swath images that form the printed diagnostic image, each set of print swath images having a different detectable spacing increment.

7. A printing device as recited in claim 1, wherein the pen is further configured to form the printed diagnostic image with first swath images and second swath images, the second swath images printed after the first swath images and after a print media line-feed advance.

8. A printing device as recited in claim 1, wherein the pen is further configured to form the printed diagnostic image with first swath images and second swath images, and wherein the sensor is further configured to detect different pen swath optical densities from an overlap of the first swath images and corresponding second swath images.

9. A printing device as recited in claim 1, wherein the pen is further configured to form the printed diagnostic image with first swath images and second swath images, and wherein the sensor is further configured to detect different pen swath optical densities from an alignment of the first swath images with corresponding second swath images.

10. A printing device as recited in claim 1, wherein the pen is further configured to form the printed diagnostic image with first swath images and second swath images, the second swath images printed after the first swath images and after a print media line-feed advance, and wherein the sensor is further configured to detect different pen swath optical densities from an offset between the first swath images and corresponding second swath images.

11. A printing device as recited in claim 1, wherein the application component is further configured to average multiple pen swath optical densities to determine the pen swath height error compensation factor.

12. A printing device as recited in claim 1, further comprising at least a second pen configured to transfer an imaging medium onto the print media to form a second printed diagnostic image, wherein:
the sensor is further configured to detect second pen swath optical densities from the second printed diagnostic image;
the application component is further configured to determine a second pen swath height error compensation factor from the second pen swath optical densities;
the application component is further configured to determine an optimal swath height error compensation factor from the pen swath height error compensation factor and the second pen swath height error compensation factor; and
the print media line-feed advance offset is further configured to be calibrated corresponding to the optimal swath height error compensation factor.

13. A printing device as recited in claim 1, further comprising at least a second pen configured to transfer an imaging medium onto the print media to form a second printed diagnostic image, wherein:
the sensor is further configured to detect second pen swath optical densities from the second printed diagnostic image;
the application component is further configured to determine a second pen swath height error compensation factor from the second pen swath optical densities; and
the print media line-feed advance offset is further configured to be calibrated corresponding to the second pen swath height error compensation factor.

14. A printing device as recited in claim 13, wherein the application component is further configured to average the pen swath optical densities and the second pen swath optical densities to determine an averaged swath height error compensation factor.

15. A printing device as recited in claim 13, wherein the application component is further configured to average the pen swath optical densities and the second pen swath optical densities to determine an averaged swath height error compensation factor, and wherein the print media line-feed advance offset is further configured to be calibrated corresponding to the averaged swath height error compensation factor.

16. A printing device, comprising:
a pen configured to transfer an imaging medium onto a print media to form a printed diagnostic image;
a sensor configured to detect pen swath optical densities from the printed diagnostic image; and
an application component configured to determine a print media linefeed advance offset from the pen swath optical densities.

17. A printing device as recited in claim 16, wherein the pen is further configured to transfer the imaging medium onto the print media to form multiple sets of printed diagnostic images, and wherein the sensor is further configured to detect the pen swath optical densities from the multiple sets of printed diagnostic images.

18. A printing device as recited in claim 16, wherein the pen is further configured to print first swath images and at least second swath images to form the printed diagnostic image.

19. A printing device as recited in claim 16, wherein the pen is further configured to print first swath images and second swath images to form the printed diagnostic image, the second swath images printed after the first swath images and after a print media line-feed advance.

20. A printing device as recited in claim 16, wherein the pen is further configured to print first swath images and second swath images to form the printed diagnostic image, and wherein the sensor is further configured to detect different pen swath optical densities from an overlap of the first swath images and corresponding second swath images.

21. A printing device as recited in claim 16, wherein the pen is further configured to print first swath images and second swath images to form the printed diagnostic image, and wherein the sensor is further configured to detect different pen swath optical densities from an alignment of the first swath images with corresponding second swath images.

22. A printing device as recited in claim 16, wherein the pen is further configured to print first swath images and second swath images to form the printed diagnostic image, the second swath images printed after the first swath images and after a print media line-feed advance, and wherein the sensor is further configured to detect different pen swath optical densities from an offset between the first swath images and corresponding second swath images.

23. A printing device as recited in claim 16, wherein the application component is further configured to average multiple pen swath optical densities to determine the print media line-feed advance offset.

24. A printing device as recited in claim 16, further comprising at least a second pen configured to transfer an imaging medium onto the print media to form a second printed diagnostic image, wherein:
the sensor is further configured to detect second pen swath optical densities from the second printed diagnostic image; and
the application component is further configured to determine an optimal print media line-feed advance offset from the pen swath optical densities and the second pen swath optical densities.

25. A printing device as recited in claim 24, wherein the application component is further configured to average the pen swath optical densities and the second pen swath optical densities.

26. A method to correct printing mechanism swath height and line-feed advance errors, comprising:
printing a diagnostic image on a print media;
detecting pen swath optical densities from the diagnostic image;
determining an error compensation factor from the pen swath optical densities; and
offsetting a print media line-feed advance corresponding to the error compensation factor.

27. A method as recited in claim 26, further comprising printing multiple sets of diagnostic images on the print media, and wherein detecting includes detecting the pen swath optical densities from the multiple sets of diagnostic images.

28. A method as recited in claim 26, wherein printing includes forming the diagnostic image with first swath images and second swath images.

29. A method as recited in claim 26, wherein printing includes printing first swath images on the print media, advancing the print media, and printing second swath images on the print media, the first swath images and the second swath images forming the diagnostic image.

30. A method as recited in claim 26, wherein printing includes forming the diagnostic image with first swath images and second swath images, and wherein detecting includes detecting different pen swath optical densities from an overlap of the first swath images and corresponding second swath images.

31. A method as recited in claim 26, wherein printing includes forming the diagnostic image with first swath images and second swath images, and wherein detecting includes detecting different pen swath optical densities from an alignment of the first swath images with corresponding second swath images.

32. A method as recited in claim 26, wherein printing includes printing first swath images on the print media, advancing the print media, and printing second swath images on the print media, the first swath images and the second swath images forming the diagnostic image, and wherein detecting includes detecting different pen swath optical densities from an offset between the first swath images and corresponding second swath images.

33. A method as recited in claim 26, wherein determining includes averaging multiple pen swath optical densities to determine the error compensation factor.

34. A method as recited in claim 26, further comprising printing a second diagnostic image on the print media, wherein:
detecting includes detecting second pen swath optical densities from the second diagnostic image;
determining includes determining an optimal error compensation factor from the pen swath optical densities and the second pen swath optical densities; and
offsetting includes offsetting the print media line-feed advance corresponding to the optimal error compensation factor.

35. A method as recited in claim 26, further comprising printing a second diagnostic image on the print media with at least a second pen, wherein:
detecting includes detecting second pen swath optical densities from the second diagnostic image;
determining includes determining a second error compensation factor from the second pen swath optical densities; and
offsetting includes offsetting the print media line-feed advance corresponding to the second error compensation factor.

36. A method as recited in claim 35, wherein determining further includes averaging the pen swath optical densities and the second pen swath optical densities to determine an averaged error compensation factor, and wherein offsetting further includes offsetting the print media line-feed advance corresponding to the averaged error compensation factor.

37. A method to determine a printing device media line-feed advance offset, comprising:
printing first swath images and second swath images;
detecting a first optical density correlating to a first offset between the first swath images and corresponding second swath images;
detecting at least a second optical density correlating to a second offset between the first swath images and corresponding second swath images;
determining the printing device media line-feed advance offset from the detected optical densities.

38. A method as recited in claim 37, wherein determining includes averaging the detected optical densities.

39. A method as recited in claim 37, wherein determining includes selecting a lowest optical density value from the detected optical densities.

40. A method as recited in claim 37, wherein printing includes printing the first swath images and second swath images with one pen to form a diagnostic image.

41. A method as recited in claim 37, further comprising detecting multiple optical densities correlating to multiple different offsets between the first swath images and corresponding second swath images, and wherein determining includes determining an optimal optical density from the detected multiple optical densities.

42. One or more computer-readable media comprising computer executable instructions that, when executed, direct a printing device to perform a method comprising determining a pen swath height and print media line-feed advance error compensation factor from pen swath optical densities detected from a printed diagnostic image.

43. One or more computer-readable media as recited in claim 42, wherein the method further comprises calibrating a print media line-feed advance offset corresponding to the error compensation factor.

44. One or more computer-readable media comprising computer executable instructions that, when executed, direct a printing device to perform a method to correct printing mechanism swath height and line-feed advance errors, comprising:
printing a diagnostic image on a print media;
detecting pen swath optical densities from the diagnostic image; and
determining a line-feed advance offset from the pen swath optical densities.

45. One or more computer-readable media as recited in claim 44, wherein the method further comprises printing multiple sets of diagnostic images on the print media, and wherein detecting includes detecting the pen swath optical densities from the multiple sets of diagnostic images.

46. One or more computer-readable media as recited in claim 44, wherein printing includes printing first swath images and second swath images to form the diagnostic image.

47. One or more computer-readable media as recited in claim 44, wherein printing includes printing first swath images on the print media, advancing the print media, and printing second swath images on the print media, the first swath images and the second swath images forming the diagnostic image.

48. One or more computer-readable media as recited in claim 44, wherein printing includes printing first swath images and second swath images to form the diagnostic image, and wherein detecting includes detecting different pen swath optical densities from an overlap of the first swath images and corresponding second swath images.

49. One or more computer-readable media as recited in claim 44, wherein printing includes printing first swath images and second swath images to form the diagnostic image, and wherein detecting includes detecting different pen swath optical densities from an alignment of the first swath images with corresponding second swath images.

50. One or more computer-readable media as recited in claim 44, wherein printing includes printing first swath images on the print media, advancing the print media, and printing second swath images on the print media, the first swath images and the second swath images forming the diagnostic image, and wherein detecting includes detecting different pen swath optical densities from an offset between the first swath images and corresponding second swath images.

51. One or more computer-readable media as recited in claim 44, wherein determining includes averaging multiple pen swath optical densities to determine the line-feed advance offset.

52. One or more computer-readable media as recited in claim 44, wherein the method further comprises printing a second diagnostic image on the print media, wherein:
detecting includes detecting second pen swath optical densities from the second diagnostic image; and
determining includes determining an optimal line-feed advance offset from the pen swath optical densities and the second pen swath optical densities.
